(19) United States
(12) Patent Application Publication
(10) Pub. No.: US 2024/0193429 A1
(43) Pub. Date: Jun. 13, 2024

(54) PARALLELIZING MOMENT-BASED OPTIMIZATIONS WITH BLOCKWISE MODEL-UPDATE FILTERING

(71) Applicant: Microsoft Technology Licensing, LLC, Redmond, WA (US)

(72) Inventors: Kai CHEN, Beijing (CN); Qiang HUO, Beijing (CN); Haisong DING, Beijing (CN)

(21) Appl. No.: 18/279,754

(22) PCT Filed: Apr. 19, 2021
(86) PCT No.: PCT/CN2021/088167

§ 371 Date: Aug. 31, 2023

(51) Int. Cl. G06N 3/091

(52) U.S. Cl. CPC G06N 3/091

(57) ABSTRACT

In embodiments of the present disclosure, there is provided a solution for parallelizing moment-based optimization with blockwise model-update filtering. A master node provides a global model parameter and a global moment parameter to a plurality of worker node for a training cycle s, and receives, from the worker nodes, a plurality of local model parameters and a plurality of local moment parameters generated by the worker nodes performing parallel moment-based optimizations. The global model parameter and the global moment parameter are updated based on the corresponding received local parameters and model update information for the training cycle. The updated global model parameter and the updated global moment parameter are then provided to the worker nodes for performing moment-based optimizations in parallel for a succeeding training cycle. Embodiments of the present disclosure can achieve better and faster convergence of the training process.

### BACKGROUND

Optimizers are used to find optimal parameters of a neural network such as weights to minimize losses. With increasing amount of training data and model size of neural networks, an efficient and fast optimizer is of great importance and helps train neural networks to get to the optimal parameters more quickly and accurately. Gradient descent is one of the most popular ways to perform optimization for neural networks, and Adaptive Moment Estimation (Adam) is a widely used adaptive learning rate stochastic gradient descent optimizer based on adaptive estimates of lower-order moments for each parameter (D. P. Kinagma, J. Ba, “Adam: a method for stochastic optimization,” Proc. ICLR-2015, which is incorporated herein by reference in its entirety). When applied to large scale tasks, Adam is often combined with a synchronous stochastic gradient (SSG) technique to speed up training process with multiple worker nodes. Training data may be partitioned into multiple splits for use by the multiple worker nodes. Starting from a common initial global model, all worker nodes update local models with respective splits of training data for several steps in parallel. This procedure is called intra-block parallel optimization.

Blockwise model-update filtering (BMUF) is a general communication efficient distributed optimization framework (K. Chen, Q. Huo, “Scalable training of deep learning machines by incremental block training with intra-block parallel optimization and blockwise model-update filtering,” Proc. ICASSP-2016, which is incorporated herein by reference in its entirety). By use of BMUF, each worker node optimizes its local model for several steps to get a local model-update in parallel, and then local model-updates by the multiple worker nodes are aggregated and filtered by a historical model-update with a block momentum to update the global model. BMUF can reduce communication overhead greatly as compared with other SSG methods and be applied for distributed training of large scale deep neural networks. BMUF has been demonstrated to work with a momentum-based stochastic gradient descent local optimizer and achieve linear speedup with little accuracy degradation in comparison with a conventional mini-batch based stochastic gradient descent optimizer on a single machine.

### SUMMARY

In embodiments of the present disclosure, there is provided a solution for parallelizing moment-based optimizations with BMUF. According to embodiments of the present disclosure, a master node provides a global model parameter and a global moment parameter to a plurality of worker nodes for a training cycle. The plurality of worker nodes perform moment-based optimization in parallel based on the global model parameter and the global moment parameter, to generate a plurality of local model parameters and a plurality of local moment parameters. The master node receives, from the plurality of worker nodes, the plurality of local model parameters and the plurality of local moment parameters. An aggregated model parameter is obtained by aggregating the plurality of local model parameters, and an aggregated moment parameter is obtained by aggregating the plurality of local moment parameters. The master node generates model update information for the training cycle based on the aggregated model parameter and historical model update information for a preceding training cycle and uses the model update information to update the global model parameter. The global moment parameter is also updated based on the aggregated moment parameter to obtain an updated global moment parameter compatible with the updated global model parameter. The updated global model parameter and the updated global moment parameter are then provided to the plurality of worker nodes for performing moment-based optimizations in parallel for a succeeding training cycle. According to embodiments of the present disclosure, a global moment parameter for the moment-based optimizations is properly updated as the global model parameter is updated, thereby achieving better and faster convergence of the training process.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The above and other features, advantages and aspects of embodiments of the present disclosure will be made more apparent by describing the present disclosure in more detail with reference to drawings. In the drawings, the same or like reference signs represent the same or like elements, wherein:

FIG. 1 illustrates a block diagram of a computing device/server in which one or more embodiments of the present disclosure may be implemented;

FIG. 2 illustrates an example system for parallelizing moment-based optimization with BMUF according to some embodiments of the present disclosure;

FIG. 3 illustrates a signaling flow for parallelizing moment-based optimizations with BMUF according to some embodiments of the present disclosure; and

FIG. 4 illustrates a flow chart of a method for parallelizing moment-based optimization with BMUF according to some embodiments of the present disclosure.

### DETAILED DESCRIPTION

Embodiments of the present disclosure will be described in more detail below with reference to figures. Although the drawings show some embodiments of the present disclosure, it should be appreciated that the present disclosure may be implemented in many forms and the present disclosure should not be understood as being limited to embodiments illustrated herein. On the contrary, these embodiments are provided herein to enable more thorough and complete understanding of the present disclosure. It should be appreciated that drawings and embodiments of the present disclosure are only used for exemplary purposes and not used to limit the protection scope of the present disclosure.

As used herein, the term “comprise” and its variants are to be read as open terms that mean “comprise, but not limited to.” The term “based on” is to be read as “based at least in part on.” The term “an embodiment” is to be read as “at least one embodiment.” The term “another embodiment” is to be read as “at least one other embodiment.” The term “some embodiments” is to be read as “at least some embodiments.” Definitions of other terms will be given in the text below.

Moment-based optimizations (such as Adam, RMSProp, Adadelta and so on), also referred to as moment-based optimizers, estimate one or more moments of stochastic gradient and use the estimated moment(s) to determine the learning rate adaptively. To parallelize moment-based optimizations in a distributed system, synchronous stochastic gradient (SSG) technique may be used. However, SSG is inefficient due to heavy communication cost.

As discussed above, BMUF is a communication efficient distributed optimization framework. If BMUF is applied to parallelize moment-based optimizations directly, after each BMUF iteration in a training cycle, the global model parameter for the multiple worker nodes for next intra-block parallel optimization will be updated. However, the stored moment parameter utilized in each moment-based optimization is not updated accordingly and thus is stale. If the stored moment parameter is used directly for intra-block parallel optimizations in a succeeding training cycle together with the updated global model parameter, the staleness of the moment parameter may lead to training errors or even training failure.

To this end, a new solution for parallelizing moment-based optimizations with BMUF is proposed. In view of the training errors or training failure caused by the incompatibility between the updated global model parameter and the stale moment parameter as described above, embodiments of the present disclosure properly update a global moment parameter used in the moment-based optimizations as the global model parameter is updated for a training cycle, thereby achieving better and faster convergence of the training process. In addition, embodiments of the present disclosure can have almost a linear speedup in the training with the increasing number of worker nodes while ensuring the training accuracy, and outperform the conventional SSG technique in terms of speedup ratio, scalability, and training accuracy.

Reference is made to the figures below to illustrate the basic principles and several example embodiments of the present disclosure herein.

### Example Device and System

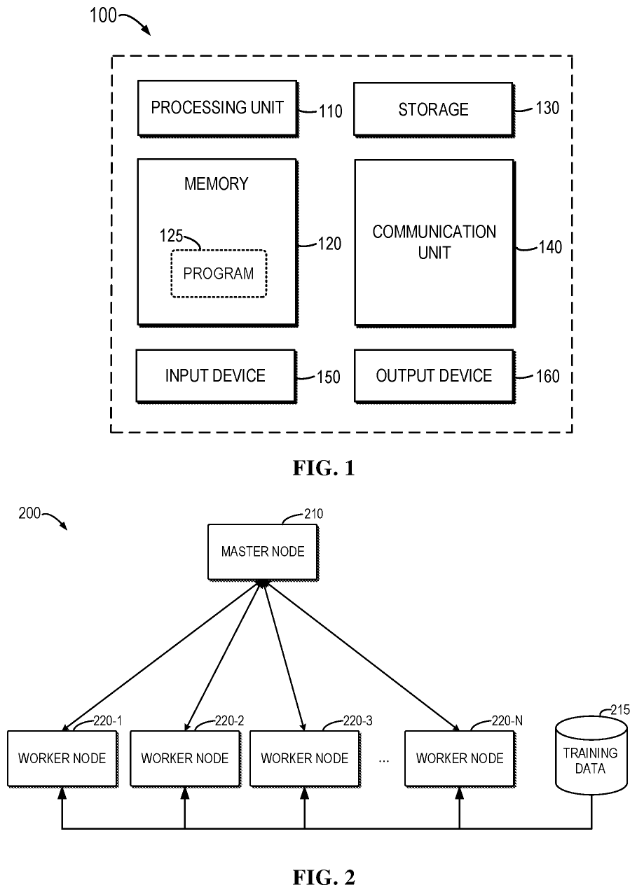

FIG. 1 illustrates a block diagram of a computing device/server 100 in which one or more embodiments of the present disclosure may be implemented. It would be appreciated that the computing device/server 100 as described in FIG. 1 is merely for illustration but not limit the function and scope of embodiments of the present disclosure in any manners. For example, the computing device/server 100 may be a computer or a server.

As shown in FIG. 1, components of the computing device/server 100 may include, but are not limited to, one or more processor(s) or processing unit(s) 110, a memory 120, a storage device 130, one or more communication unit(s) 140, one or more input device(s) 150, and one or more output device(s) 160. The processing unit 110 may be a physical or virtual processor and perform various processes based on programs stored in the memory 120. In a multiprocessor system, a plurality of processing units may execute computer executable instructions in parallel to improve parallel processing capability of the computing device/server 100.

The computing device/server 100 typically includes various computer storage media. The computer storage media may be any media accessible by the computing device/server 100, including but not limited to volatile and non-volatile media, or removable and non-removable media. The memory 120 can be a volatile memory (for example, a register, cache, Random Access Memory (RAM)), non-volatile memory (for example, a Read-Only Memory (ROM), Electrically Erasable Programmable Read-Only Memory (EEPROM), flash memory), or any combination thereof.

As shown in FIG. 1, the memory 120 may include a program 125 for parallelizing moment-based optimizations with blockwise model-update filtering (BMUF) according to embodiments of the present disclosure, which may have one or more sets of program modules configured to execute methods and functions of various embodiments described herein. The storage device 130 may be any removable or non-removable media and include machine-readable media such as a flash drive, disk, and any other media, which can be used for storing information and/or data and accessed within the computing device/server 100. For example, the storage device 130 may be a hard disc drive (HDD) or a solid state drive (SSD).

The computing device/server 100 may further include additional removable/non-removable or volatile/non-volatile storage media. Although not shown in FIG. 1, a magnetic disk drive is provided for reading and writing from/to a removable and non-volatile disk (e.g., “a floppy disk”) and an optical disk drive may be provided for reading or writing from/to a removable non-volatile optical disk. In such cases, each drive is connected to the bus (not shown) via one or more data media interfaces.

The communication unit 140 communicates with other computing devices via communication media. Additionally, functions of components in the computing device/server 100 may be implemented in a single computing cluster or a plurality of computing machines that are communicated with each other via communication connections. Therefore, the computing device/server 100 may be operated in a networking environment using a logical connection to one or more other servers, network personal computers (PCs), or another network node.

The input device 150 may include one or more input devices such as a mouse, keyboard, tracking ball and the like. The output device 160 may include one or more output devices such as a display, loudspeaker, printer, and the like. The computing device/server 100 may further communicate, via the communication unit 140, with one or more external devices (not shown) such as a storage device or a display device, one or more devices that enable users to interact with the computing device/server 100, or any devices that enable the computing device/server 100 to communicate with one or more other computing devices (for example, a network card, modem, and the like). Such communication can be performed via input/output (I/O) interfaces (not shown).

FIG. 2 illustrates an example system 200 for parallelizing moment-based optimizations with BMUF according to some embodiments of the present disclosure. As shown in FIG. 2, the example system 200 may be a distributed system and comprise a master node (or master) 210 and a plurality of (“N”) worker nodes, including worker nodes (or workers) 220-1, 220-2, 220-3, . . . , 220-N (collectively or individually referred to as worker nodes 220). In some embodiments, the master node 210 and the worker nodes 220 may be different computing devices. In some embodiments, the computing devices may include general purpose computers (such as desktop computers, laptop computers, servers), various types of processors (such as central processor units (CPUs), graphics processor units (GPUs), virtual processors, and so on).

The system 200 further comprises training data 215, which may be stored in one or more storage devices. The training data 215 may be used for training various machine learning models, such as a convolutional neural network (CNN), a recurrent neural network (RNN), an attention based neural network, their variants and so on. The training process is to determine an optimal value for a parameter of a model (referred to as a “model parameter”) by iteratively updating the model parameter from its initial value. The example system 200 may be configured as a single computer system, or a computer cluster, or other architectures used in a cloud-computing infrastructure.

The system 200 may be used for various tasks, examples of which include, but are not limited to, a large-scale optical character recognition (OCR) task and a large vocabulary continuous speech recognition (LVCSR) task. In the character recognition task, the training data 215 may include labeled images, handwriting samples and so on. In the speech recognition task, the training data 215 may be a speech corpus that includes a collection of speech samples collected from human speakers. For example, the speech corpus may include English speech samples collected from English speakers and/or Chinese speech samples collected from Chinese speakers, and so on.

The master node 210 and the worker nodes 220 can be operated to implement BMUF in the training process. According to BMUF, the master node 210 may assign data splits of the training data 215 to the worker nodes 220 and synchronize the model parameters with the worker nodes 220, and the worker nodes 220 may perform the local training with respective data splits of the training data 215. In some embodiments, the master node 210 may communicate with the worker nodes 220 via various wireless and/or wired communication technologies.

According to embodiments of the present disclosure, it is proposed to parallelize moment-based optimizations with BMUF. To better understand the embodiments of the present disclosure, work principles of BMUF and parallelizing moment-based optimizations are briefly introduced first. The embodiments of parallelizing moment-based optimizations with BMUF will then be discussed in detail.

### BMUF-Based Framework

To implement BMUF in a distributed system (e.g., the system 200), N worker nodes may be exploited to perform intra-block parallel optimizations. For each training cycle (also referred to as BMUF iteration), given a data block for training, it may be partitioned into N data splits to be provided to the N worker nodes, and each data split may contain a predetermined number (“τ”) of mini-batches. A master node maintains a global model parameter and provides it to each of the N worker nodes in each training cycle. Each worker node uses the global model parameter as an initial model parameter and processes τ mini-batches of a data split in each training cycle to optimize the model parameter in parallel. As a result, N local model parameters {θ_{t,1}, θ_{t,2}, . . . , θ_{t,N}} are generated at the N worker nodes in a training cycle n at step t, t=n·τ.

The master node may obtain the N local model parameters {θ_{t,1}, θ_{t,2}, . . . , θ_{t,N}} from the worker nodes to perform an update on the global model parameter. The master node may calculate an aggregated model parameter θ̅ₜ, for example, by averaging the N local model parameters. Instead of simply treating the aggregated model parameter θ̅ₜ as an initial model parameter for a succeeding training cycle, BMUF uses a block momentum to combine historical model update information to compensate per mini-batch's inadequate contribution to model update caused by the aggregation operation. Model update information Δₙ for the training cycle n may be determined by equation (1):

Δₙ=η·Δₙ₋₁+ζ·(θ̅ₜ−θ_{t-τ}^{(init)}) (1)

where Δₙ₋₁ represents historical model update information for a preceding training cycle n−1, η represents a block momentum for a data block, ζ represents a block learning rate for a data block, and θ_{t-τ}^{(init)} represents the global model parameter that is provided to the N worker nodes as their initial model parameter for the training cycle n for the intra-block parallel optimization. The block momentum η and the block learning rate ζ may be set dependent on individual training cycles or constant in the training. The block momentum η may be determined based on the number of worker nodes exploited for the training. The block learning rate may be determined as any appropriate value according to training tasks and/or requirements. In some embodiments, η may be set to

$$1 - \frac{1}{N}$$

or closer to

$$1 - \frac{1}{N} ,$$

where N is the number of the worker nodes. The value of the block learning rate ζ may be set as 1 or approximately to 1.

Then, starting from an updated global model parameter θ_{t-τ} for the preceding training cycle n−1 at step t−τ, the model update information Δₙ may be used to update θ_{t-τ} to get an updated global model parameter θₜ for the training cycle n at step t, as shown in equation (2):

θₜ=θ_{t-τ}+Δₙ (2)

If classical block momentum (CBM) is used in BMUF, the global model parameter provided as an initial model parameter for a succeeding training cycle n+1 of intra-block parallel optimization may be the same with the updated global model parameter determined in equation (2), which may be rewritten as follows.

θₜ^{(init)}=θₜ=θ_{t-τ}^{(init)}+ζ·(θ̅ₜ−θ_{t-τ}^{(init)})+η·Δₙ₋₁ (3)

If Nesterov block momentum (NBM) is used in BMUF, the global model parameter provided as an initial model parameter for a succeeding training cycle may be as shown in equation (4).

θₜ^{(init)}=θₜ+η·Δₙ (4)

### Since

θₜ=θ_{t-τ}+η·Δₙ₋₁+ζ·(θ̅ₜ−θ_{t-τ}^{(init)})=θ_{t-τ}^{(init)}+ζ(θ̅ₜ−θ_{t-τ}^{(init)}) (5)

The global model parameter provided as the initial model parameter for the succeeding training cycle may be obtained by substituting equation (5) in equation (4), as shown in equation (6).

θₜ^{(init)}=θ_{t-τ}^{(init)}+ζ·(θ̅ₜ−θ_{t-τ}^{(init)})+η·Δₙ (6)

### Moment-Based Optimization

As mentioned above, moment-based optimization is adaptive learning rate stochastic gradient descent optimization, to estimate one or more moments of stochastic gradient and use the estimated moment(s) to determine the learning rate adaptively. There are many algorithms of moment-based optimizations available for use, of which Adam optimization is widely used. Adam optimization is briefly introduced here as an example.

Adam optimization uses exponential moving average and bias correction to approximate true moments. Adam optimization aims to estimate a first-order moment mₜ and a second-order moment vₜ of stochastic gradient at step t, as shown in following equations:

mₜ=β₁mₜ₋₁+(1−β₁)gₜ (7)

vₜ=β₂vₜ₋₁+(1−β₂)gₜ⊙gₜ (8)

where β₁ and β₂ represents a first and a second exponential decay rates for the moment estimates, respectively; gₜ represents stochastic gradient of the t-th step; and ⊙ represents element-wise multiplication. In above equations (7) and (8), mₜ and vₜ are estimated moments obtained by exponential moving average. By applying bias correction to the moments mₜ and vₜ, in some examples, the bias corrected moments may be determined as follows:

$${\hat{m}}_{t} = \frac{{m}_{t}}{1 - {β}_{1}^{t}} \qquad ( 9 A )$$

$${\hat{v}}_{t} = \frac{{v}_{t}}{1 - {β}_{2}^{t}} \qquad ( 9 B )$$

### BMUF-Moment-Based Optimization Framework

Embodiments of the present disclosure aim to plug moment-based optimization into the BMUF-framework so as to achieve parallel moment-based optimization to accelerate the training speed without scarifying training stability and accuracy. As mentioned above, moment-based optimization gets an estimation of a moment parameter of stochastic gradient at individual step t (for example, the first-order moment and second-order moment mₜ and vₜ for Adam optimization). By combining moment-based optimization with BMUF, each worker node may perform moment-based optimization operations for τ steps with τ mini-batches of a data split in each intra-block parallel optimization. The present inventors observed that directly combining BMUF with moment-based optimization will have technical problems and result in degradation of training stability and accuracy.

If directly applying BMUF to moment-based optimization, the worker nodes may report their local moment parameters after the τ steps of moment-based optimizations in each training cycle. A straightforward way to update the moment parameter is to aggregate the local moments received from the N worker nodes. Still taking Adam optimization as an example, the local moments may be aggregated by averaging to update the moment parameter as follows:

$${m}_{t}^{( init )} = {\overline{m}}_{t} = \frac{1}{N} {\sum }_{i = 1}^{N} {m}_{t , i} \qquad ( 10 )$$

$${v}_{t}^{( init )} = {\overline{v}}_{t} = \frac{1}{N} {\sum }_{i = 1}^{N} {v}_{t , i}$$

where m_{t,i} and v_{t,i} are local first-order moment and local second-order moment determined by the i-th worker node respectively at the t-th step for a training cycle n, t=n·τ; m̅ₜ and v̅ₜ are aggregated first-order moment and aggregated second-order moment respectively; and mₜ^{(init)} and vₜ^{(init)} are updated global first-order moment and global second-order moment provided for use by the N worker nodes in a succeeding training cycle.

The aggregated first-order moment and second-order moment m̅ₜ and v̅ₜ are only compatible with the aggregated model parameter θ̅ₜ in BMUF. If the aggregated first-order and second-order moments m̅ₜ and v̅ₜ are used directly in next τ Adam steps in combination with the global model parameter θₜ^{(init)}, the inventors have tested that the aggregated first-order and second-order moments m̅ₜ and v̅ₜ will be stale for θₜ^{(init)} due to the model update information Δₙ as shown in above equation (1), and the staleness of the moment estimation will lead to degradation of training stability and accuracy or even training failure.

Based on the above observations, embodiments of the present disclosure provide adjustment to the moment parameter utilized by the worker nodes in the parallel moment-based optimizations to make it compatible with the global model parameter. Specifically, each of the N worker nodes uses a global model parameter as an initial model parameter to perform moment-based optimizations with τ mini-batches of a data split in a training cycle for intra-block parallel optimization. Model update information Δₙ as determined in equation (1) is then used to update the global model parameter (for example, according to equation (3) for BMUF-CBM and equation (6) for BMUF-NBM). Equation (1) can be rewritten as follows:

$${Δ}_{n} = {\sum }_{i = 1}^{n} {η}^{n - i} ζ ( {\overline{θ}}_{i τ} - {θ}_{i τ - τ}^{( init )} ) \qquad ( 11 )$$

The block momentum η is used to filter the aggregated model parameter with historical model update information to compensate per-mini-batch's inadequate contribution to the model update information.

Based on the above equation (11), a variable may be defined (denoted as ρₙ) that represents the number of equivalent mini-batches required to obtain the model update information Δₙ. The number of equivalent mini-batches ρₙ may be determined by converting the number of mini-batches used to obtain the model update information Δₙ, as follows:

ρ₁=ζτ

ρₙ=ηρₙ₋₁+ζτ (12)

It can be seen from the equation (12) that number of equivalent mini-batches ρ₁ for the first training cycle corresponds to the model update Δ₁, which is determined by converting τ mini-batches for the first training cycle give the existence of the block learning rate ζ; and the number of equivalent mini-batches ρₙ for the training cycle n corresponds to the model update information Δₙ, which may be determined iteratively based on the number of equivalent mini-batches for the preceding training cycle n−1, representing a converted number of mini-batches used to obtain the model update information Δₙ.

It can be seen from the equation (12) that as training cycle n increases,

$${lim}_{n \to ∞} {ρ}_{n} = \frac{ζ τ}{1 - η} .$$

In some embodiments, η may be set to

$$1 - \frac{1}{N}$$

or closer to

$$1 - \frac{1}{N} ,$$

where N is the number of the worker nodes. The block learning rate ζ may be set to 1 or approximately to 1. Accordingly,

$${lim}_{n \to + ∞} {ρ}_{n} = N τ ,$$

which is equal to the number of mini-batches of a data block. Thus, as the training cycle n increases, lim_{n→+∞}Δₙ can simulate an update of the model parameter resulting from processing a data block with Nτ mini-batches in serial if it is assumed that (θ̅ₜ−θ_{t-τ}^{(init)}) is stationary.

From the above analysis, to make the global moment parameter compatible with the global model parameter, the global moment parameter may be updated for each training cycle based on the number of equivalent mini-batches required to obtain the model update information. The updated global moment parameter may be provided as an initial moment parameter for the worker nodes to perform moment-based optimizations in parallel for a succeeding training cycle.

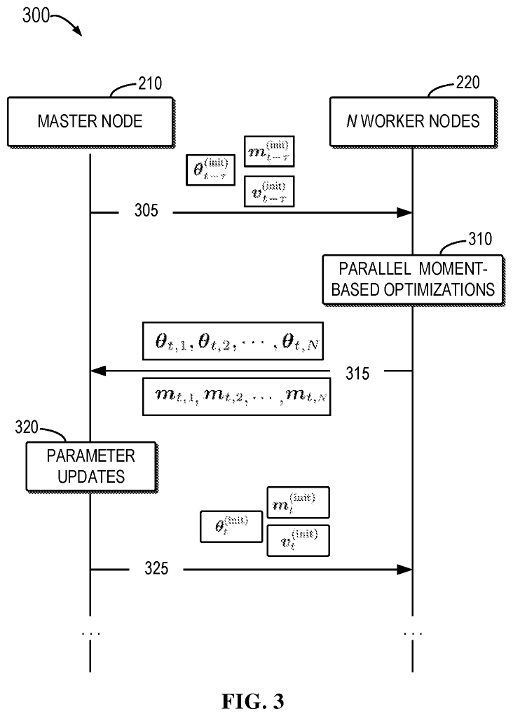

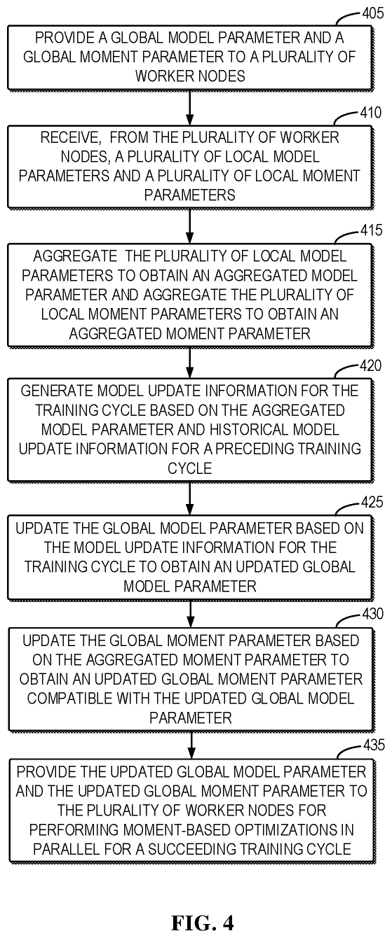

The updates of the global model parameter together with the global moment parameter will be described in further detail with reference to FIG. 3, which shows a signaling flow 300 for parallelizing moment-based optimizations with BMUF according to some example embodiments of the present disclosure. For the purpose of discussion, the signaling flow 300 will be described with reference to FIG. 2. The signaling flow 300 involves the master node 210 and the N worker nodes 220 in the system 200 as illustrated in FIG. 2.

In operation, the master node 210 provides 305 a global model parameter and a global moment parameter to the N worker nodes 220 in the system 200 for a training cycle. For example, the master node 210 may broadcast the global model parameter and the global moment parameter to the N worker nodes 220 via their communication connections.

The global model parameter may be represented as θ_{t-τ}^{(init)}. This global model parameter may be treated as an initial model parameter and are optimized by each of the worker nodes 220 in the training cycle. As mentioned above, according to BMUF, a data block of the training data 215 is split into N data splits in each training cycle, each comprising τ mini-batches. Each of the worker nodes 220 may use the τ mini-batches for training, so as to optimize the initial model parameter.

As the worker nodes 220 are configured to perform moment-based optimizations, the global moment parameter is provided as an initial moment parameter in the training cycle. The global moment parameter may include one or more moments utilized for moment-based optimizations at the worker nodes 220. Different moments may be estimated depending on the algorithms applied for the moment-based optimization. In the embodiments of FIG. 3, the Adam optimization is described as an example, in which the global model parameter comprises a global first-order moment of stochastic gradient (represented as m_{t-τ}^{(init)}) and a global second-order moment of stochastic gradient (represented as v_{t-τ}^{(init)}) in the Adam optimization. Other example moment-based optimizations will be further discussed in the following.

In some embodiments, the global model parameter θ₀ and the global moment parameter m₀^{(init)} and v₀^{(init)} may be initiated as zero or other predetermined values for the first training cycle (e.g., the training cycle 1). With τ mini-batches processed by the worker nodes for the first training cycle, the initial global model parameter and the initial global moment parameter may be updated to obtain an updated global model parameter and an updated global moment parameter, and the updated global model parameter and the updated global moment parameter may be provided as an initial model parameter and an initial moment parameter for a succeeding training cycle (e.g. the training cycle 2, . . . , n).

The N worker nodes 220, upon reception of the global model parameter and the global moment parameter, perform 310 moment-based optimizations in parallel for the training cycle, to generate a plurality of local model parameters and a plurality of local moment parameters. Each of the worker nodes 220 may perform moment-based optimizations (for example, Adam optimizations) based on the global model parameter and the global moment parameter by processing the τ mini-batches of training data.

For the moment-based optimizations, a worker node 220 may determine a local moment parameter through the stochastic gradient descent technique. For example, for an i-th worker node 220, by processing a t-th mini-batch of the τ mini-batches at a t-th step, the stochastic gradient of the t-th mini-batch g_{t,i} is determined as

$$\frac{\partial {f}_{t} ( θ )}{\partial {θ}_{t - 1 , i}} ,$$

where f ( ) represents the stochastic objective function. For Adam optimization, a local first-order moment and a local second-order moment m_{t,i} and v_{t,i} may be determined by the i-th worker node 220 respectively at the t-th step, according to equations (7) and (8) respectively based on the stochastic gradient g_{t,i}. In some embodiments, the i-th worker node 220 may further apply a bias correction term to the local first-order moment and the local second-order moment m_{t,i} and v_{t,i} according to the equations (9A) and (9B), to obtained a bias corrected local first-order moment and a bias corrected local second-order moment, represented as \hat{m}_{t,i} and \hat{v}_{t,i}, respectively.

The i-th worker node 220 may determine a local model parameter (represented as θ_{t,i}) based on the two local moments m_{t,i} and v_{t,i}, or based on the two local bias corrected moments \hat{m}_{t,i} and \hat{v}_{t,i}. In an example where the bias correction is applied, the local model parameter θ_{t,i} at the t-th step may be determined as θ_{t-1,i}−α\hat{m}_{t,i}/(ϵ+\sqrt{\hat{v}_{t,i}}), where α represents step size (e.g., α=0.001) and ϵ is a small scalar (e.g., ϵ=10⁻⁸).

The N worker nodes 220 perform their moment-based optimizations in parallel. The local moments m_{t,i} and v_{t,i} and the local model parameter θ_{t,i} may be generated iteratively at the i-th worker node 220 until the τ mini-batches are processed. In the signaling flow 300, the N worker nodes 220 send 315 their local moment parameters (e.g., local moments m_{t,i} and v_{t,i}) and the local model parameters θ_{t,i} (i=1, 2, . . . , N) to the master node 210. The local moments m_{t,i} and v_{t,i} and the local model parameter θ_{t,i} sent to the master node 210 are those determined at step t=nτ.

Upon receiving the local moment parameters (e.g., the local moments m_{t,i} and v_{t,i}) and the local model parameters θ_{t,i} (i=1, 2, . . . , N) from the worker nodes 220, the master node 210 performs 320 parameter updates, to determine an updated global model parameter based on the local model parameters and determine an update global moment parameter based on local moment parameters.

Specifically, to determine an updated global model parameter, the master node 210 aggregates the local model parameters θ_{t,i} (i=1, 2, . . . , N) to obtain an aggregated model parameter θ̅ₜ. For example, the master node 210 may determine the aggregated model parameter by averaging the plurality of local model parameters received from the worker nodes 220. The master node 210 further generates model update information for the training cycle based on the aggregated model parameter θ̅ₜ and historical model update information for a preceding training cycle. The master node 210 then updates the global model parameter θ_{t-τ}^{(init)} for the training cycle based on the model update information for the training cycle, to obtain an updated global model parameter for use as the initial model parameter θₜ^{(init)} in a succeeding training cycle.

The global model parameter provided as the initial model parameter θₜ^{(init)} for the succeeding training cycle may be determined depending on the BMUF algorithms adopted for the training. In an embodiment, for BMUF-CBM, the global model parameter θₜ^{(init)} for the succeeding training cycle may be determined by updating the global model parameter θ_{t-τ}^{(init)} for the training cycle based on the model update information Δₙ according to the above equations (2) and (3).

In another embodiment, for BMUF-NBM, the global model parameter θₜ^{(init)} for the succeeding training cycle may be determined by updating the global model parameter θ_{t-τ}^{(init)} for the training cycle based on the model update information Δₙ according to the above equations (2) and (6).

To determine an updated global moment parameter, the master node 210 aggregates the local moment parameters (e.g., local first-order and second-order moments m_{t,i} and v_{t,i}), to obtain an aggregated moment parameter (e.g., aggregated first-order and second-order moments m̅ₜ and v̅ₜ). For example, the master node 210 may determine the aggregated first-order moment m̅ₜ by averaging the plurality of local first-order moments received from the worker nodes 220, and determine the aggregated first-order moment v̅ₜ by averaging the plurality of local second-order moments received from the worker nodes 220. The master node 210 further updates the global moment parameter based on the aggregated moment parameter to obtain an updated global moment parameter (e.g., mₜ^{(init)} and vₜ^{(init)}) compatible with the global model parameter θₜ^{(init)} for use as the initial moment parameter in the succeeding training cycle.

In some embodiments, as explained above, the model update information Δₙ for the training cycle n may be treated as being obtained by processing the number of equivalent mini-batches ρₙ as shown in the above equation (12). The global moment parameter may then be updated based on the aggregated moment parameter and the number of equivalent mini-batches for the training cycle n, so as to be compatible with the global model parameter θₜ^{(init)}.

From the above analysis, the updated global moment parameter may be determined as follows (still taking Adam-optimization as an example).

According to the above equation (7), a local first-order moment m_{t,i} received from the i-th worker node 220 may be determined as follows:

$$\begin{matrix}{m}_{t , i} = {β}_{1} {m}_{t - 1 , i} + ( 1 - {β}_{1} ) {g}_{t , i} = {β}_{1} ( {β}_{1} {m}_{t - 2 , i} + \\ ( 1 - {β}_{1} ) {g}_{t - 1 , i} ) + ( 1 - {β}_{1} ) {g}_{t , i} \\ = {β}_{1}^{2} {m}_{t - 2 , i} + ( 1 - {β}_{1} ) {β}_{1} {g}_{t - 1 , i} + ( 1 - {β}_{1} ) {g}_{t , i} = … \\ = {β}_{1}^{τ} {m}_{t - τ , i} + ( 1 - {β}_{1} ) {β}_{1}^{τ - 1} {g}_{t - τ + 1 , i} + … + \\ ( 1 - {β}_{1} ) {β}_{1} {g}_{t - 1 , i} + ( 1 - {β}_{1} ) {g}_{t , i} \\ = {β}_{1}^{τ} {m}_{t - τ , i} + {\sum }_{j = 1}^{τ} {β}_{1}^{τ - j} ( 1 - {β}_{1} ) {g}_{t - τ + j , i}\end{matrix} \qquad ( 13 A )$$

Since m_{t-τ,i}=m_{t-τ}^{(init)} (i.e., the global first-order moment for the training cycle sent to the i-th worker node 220), after taking an aggregation operation at both sides of the above equation (13A), the aggregated first-order moment m̅ₜ for the local first-order moments received from all the worker nodes 220 may be determined as follows:

$${\overline{m}}_{t} = {β}_{1}^{τ} - {m}_{t - τ}^{( init )} + {\sum }_{j = 1}^{τ} {β}_{1}^{τ - j} ( 1 - {β}_{1} ) {\overline{g}}_{t - τ + j} \qquad ( 13 B )$$

Since Adam-optimization assumes that the stochastic gradient expectation E[gₜ] is stationary, for the aggregated first-order moment m̅ₜ:

E[m̅ₜ]=β₁^{τ}E[m_{t-τ}^{(init)}]+(1−β₁^{τ})E[g⁽ⁿ⁾] (14)

m̅ₜ=β₁^{τ}m_{t-τ}^{(init)}+(1−β₁^{τ})E[g⁽ⁿ⁾] (15)

where E[g⁽ⁿ⁾] is the stochastic gradient expectation of the n-th data block. Since the aggregated model parameter θ̅ₜ may be rewritten as follows:

θ̅ₜ=θ_{t-τ}^{(init)}+(θ̅ₜ−θ_{t-τ}^{(init)}) (16)

where (θ̅ₜ−θ_{t-τ}^{(init)}) is the update to get θ̅ₜ starting from θ_{t-τ}^{(init)}, τ may be seen as the number of equivalent mini-batches required to get θ̅ₜ starting from θ_{t-τ}^{(init)}. From the above equation (15), it shows that the aggregated first-order moment m̅ₜ is only compatible with the aggregated model parameter θ̅ₜ, with a weight β₁^{τ} assigned to m_{t-τ}^{(init)} and a weight (1−β₁^{τ}) assigned to E[g⁽ⁿ⁾]. Since both the weights are fixed by the number of mini-batches τ for a training cycle no matter the number of worker nodes used, m_{t-τ}^{(init)} becomes too stale for θₜ^{(init)}, in particular when τ is small and the number of worker nodes N is large. To make the global model parameter mₜ^{(init)} compatible with the global model parameter θₜ^{(init)}, the aggregated model parameter may be updated based on the number of equivalent mini-batches ρₙ for the training cycle n.

Thus, for BMUF-CBM according to the above equation (3), where θₜ^{(init)} is obtained by updating θ_{t-τ}^{(init)} with ζ·(θ̅ₜ−θ_{t-τ}^{(init)})+η·Δₙ₋₁ (i.e., Δₙ) and the number of equivalent mini-batches ρₙ is ηρₙ₋₁+ζτ as shown in the above equation (12), the weights assigned to m_{t-τ}^{(init)} and E[g⁽ⁿ⁾] may be updated based on ρₙ as following equation (17) to make the global model parameter mₜ^{(init)} compatible with the global model parameter θₜ^{(init)}.

mₜ^{(init)}=β₁^{ζτ+ηρ}^{_{n−1}}m_{t-τ}^{(init)}+(1−β₁^{ζτ+ηρ}^{_{n−1}})E[g⁽ⁿ⁾] (17)

Since

$${lim}_{n \to + ∞} {ρ}_{n} = \frac{ζτ}{1 - η} ,$$

and if set η to

$$1 - \frac{1}{N}$$

and ζ to 1,

$${lim}_{n \to + ∞} {ρ}_{n} = N τ ,$$

the updated m_{t-τ}^{(init)}'s weight decays exponentially as the number of worker nodes N increases, and consequently its influence on mₜ^{(init)} is alleviated.

Similarly for BMUF-NBM according to the above equation (6), where θₜ^{(init)} is obtained by updating θ_{t-τ}^{(init)} with ζ·(θ̅ₜ−θ_{t-τ}^{(init)})+η·Δₙ and ρₙ is the number of equivalent mini-batches corresponding to βₙ, the weights assigned to m_{t-τ}^{(init)} and E[g⁽ⁿ⁾] may be updated based on ρₙ as following equation (18) to make the global model parameter mₜ^{(init)} compatible with the global model parameter θₜ^{(init)}. It can be seen that the value ζτ+ηρₙ used to update the weights for m_{t-τ}^{(init)} and E[g⁽ⁿ⁾] equals to the number of equivalent mini-batches for the succeeding training cycle n+1, which may be determined based on ρₙ.

mₜ^{(init)}=β₁^{ζτ+ηρ}^{ₙ}m_{t-τ}^{(init)}+(1−β₁^{ζτ+ηρ}^{ₙ})E[g⁽ⁿ⁾] (18)

From the above equation (15), E[g⁽ⁿ⁾] may be deduced as follows.

$$E [ {g}^{( n )} ] = \frac{{\overline{m}}_{t} - {β}_{1}^{τ} {m}_{t - τ}^{( init )}}{1 - {β}_{1}^{τ}} \qquad ( 19 )$$

Accordingly, for BMUF-CBM, the global first-order moment mₜ^{(init)} may be determined as shown in equation (20) and the global second-order moment vₜ^{(init)} may be determined similarly as shown in equation (21).

$${m}_{t}^{( init )} = \frac{{β}_{1}^{ζτ + {ηρ}_{n - 1}} - {β}_{1}^{τ}}{1 - {β}_{1}^{τ}} {m}_{t - τ}^{( init )} + \frac{1 - {β}_{1}^{ζτ + {ηρ}_{n - 1}}}{1 - {β}_{1}^{τ}} {\overline{m}}_{t} \qquad ( 20 )$$

$${v}_{t}^{( init )} = \frac{{β}_{2}^{ζτ + {ηρ}_{n - 1}} - {β}_{2}^{τ}}{1 - {β}_{2}^{τ}} {v}_{t - τ}^{( init )} + \frac{1 - {β}_{2}^{ζτ + {ηρ}_{n - 1}}}{1 - {β}_{2}^{τ}} {\overline{v}}_{t} \qquad ( 21 )$$

For BMUF-NBM, the global first-order moment mₜ^{(init)} may be determined as shown in equation (22) and the global second-order moment vₜ^{(init)} may be determined similarly as shown in equation (23).

$${m}_{t}^{( init )} = \frac{{β}_{1}^{ζτ + {ηρ}_{n}} - {β}_{1}^{τ}}{1 - {β}_{1}^{τ}} {m}_{t - τ}^{( init )} + \frac{1 - {β}_{1}^{ζτ + {ηρ}_{n}}}{1 - {β}_{1}^{τ}} {\overline{m}}_{t} \qquad ( 22 )$$

$${v}_{t}^{( init )} = \frac{{β}_{2}^{ζτ + {ηρ}_{n}} - {β}_{2}^{τ}}{1 - {β}_{2}^{τ}} {v}_{t - τ}^{( init )} + \frac{1 - {β}_{2}^{ζτ + {ηρ}_{n}}}{1 - {β}_{2}^{τ}} {\overline{v}}_{t} \qquad ( 23 )$$

According to the above analyses and deductions, the determination of the updated global moment parameter may be summarized as follows.

Specifically, upon reception of the local moment parameters from the worker nodes 220, the master node 210 determines the aggregated moment parameter by aggregating the plurality of local moment parameters. The master node 210 further determines the number of equivalent mini-batches ρₙ required to obtain the model update information that is used for updating the global model parameter. The number of equivalent mini-batches ρₙ may be determined iteratively based on the number of equivalent mini-batches for the preceding training cycle. The master node 210 then generates the updated global moment parameter (e.g., mₜ^{(init)} and vₜ^{(init)}) based on the aggregated moment parameter (e.g., m̅ₜ and v̅ₜ) and the number of equivalent mini-batches ρₙ. The updated global moment parameter may be provided to the worker nodes 220 as an initial moment parameter for the succeeding training cycle.

Take Adam-optimization as an example. A weight assigned to the global first-order moment m_{t-τ}^{(init)} and a weight to the aggregated first-order moment m̅ₜ may be updated based on the number of equivalent mini-batches ρₙ and the first exponential decay rate β₁. For example, for BMUF-NMB, ρₙ may be determined iteratively based on the number of equivalent mini-batches for the preceding training cycle as ηρₙ₋₁+ζτ. ζτ+ηρₙ may be further determined based on ρₙ, then a weight

$$\frac{{β}_{1}^{ζτ + {ηρ}_{n}} - {β}_{1}^{τ}}{1 - {β}_{1}^{τ}}$$

may be assigned to the global first-order moment m_{t-τ}^{(init)} and a weight

$$\frac{1 - {β}_{1}^{ζτ + {ηρ}_{n}}}{1 - {β}_{1}^{τ}}$$

may be assigned to the aggregated first-order moment m̅ₜ. Accordingly, the updated global first-order moment mₜ^{(init)} may be determined by a weighted sum of the global first-order moment m_{t-τ}^{(init)} and the aggregated first-order moment m̅ₜ with the respective assigned weights, as shown in the above equation (22).

Similarly, respective weights for the global second-order moment v_{t-τ}^{(init)} and the aggregated second-order moment v̅ₜ may be determined based on the number of equivalent mini-batches ρₙ and the first exponential decay rate β₁. The weights may then be used to calculate the updated global second-order moment vₜ^{(init)}, for example as shown in the above equation (21) for BMUF-CMB and as shown in the above equation (23) for BMUF-NBM.

In some embodiments, the inventors also found that the value of the first exponential decay rate β₁ may be set to a smaller value. For example, the value of β₁ may be set to 0.5 or close to 0.5, as compared with a value of 0.9 that is normally used in conventional Adam optimizations. In this way, the training accuracy can be further improved.

In addition, since the updated global first-order moment mₜ^{(init)} and updated global second-order moment vₜ^{(init)} are generated by updating the aggregated moments m̅ₜ and v̅ₜ based on the number of equivalent mini-batches ρₙ, in some embodiments, the bias correction terms as shown in the above equations (9A) and (9B) may be updated accordingly with regard to the number of Adam steps based on the number of equivalent mini-batches ρₙ, and the updated number of Adam steps for the bias correction terms may be used as an initial value for the succeeding training cycle.

Specifically, for BMUF-CBM, the number of Adam steps for the bias correction terms may be updated by ηρₙ₋₁+ζτ. For BMUF-NBM, the number of Adam steps for the bias correction terms may be updated by ζτ+ηρₙ. Then the updated Adam steps may be used as an initial value to calculate the bias correction terms for the succeeding training cycle.

Reference is still made to FIG. 3. With the updated global model parameter θₜ^{(init)} and the updated global moment parameter determined in the signaling flow, the master node 210 provides 325 the updated global model parameter and the updated global moment parameter to the worker nodes 220 for use in parallel moment-based optimizations for the succeeding training cycle. The worker nodes 220 may continue to perform the moment-based optimizations in parallel for the succeeding training cycle similarly as explained above, until the model parameter converges, for example, as a predefined condition is met for the training completion.

In some embodiments, one or more redundant worker nodes 220 may be included in the BMUF-moment-based optimization framework. A predefined threshold (such as N−2) may be set. In this case, if N−2 or more worker nodes 220 have completed their moment-based optimizations and reported their local model parameters and local model parameters, the master node 210 may perform the parameter updates and broadcast the updated parameters for a next training cycle, regardless of whether the remaining worker nodes 220 have completed their optimizations. In this way, the training speed of the model can be further accelerated.

By paralleling moment-based optimization within the BMUF framework and updating the global model parameter and the global moment parameter as described above, the model training process can achieve a stable and linear speedup with little training accuracy degradation. Such a training framework can provide high scalability and scale out to a large number of worker nodes (e.g., 64) in the distributed system and/or a larger number of mini-batches (e.g., 32) distributed to the worker nodes in a training cycle.

### Examples of BMUF-Adam Optimization

BMUF-Adam optimization has been discussed above, which are summarized in the following algorithms. In the following, Algorithm 1 shows an example BMUF-Adam optimization algorithm for CBM, and Algorithm 2 shows an example BMUF-Adam optimization algorithm for NBM. According to Algorithm 1 and Algorithm 2, the global first-order and second-order moments mₜ^{(init)} and vₜ^{(init)} of stochastic gradient in Adam optimization can be updated to be compatible with the global model parameter updated by BMUF.

Algorithm 1 BMUF-CBM-Adam Algorithm

Input:

number of workers N, sync period τ, block momentum η, and initial
parameter θ₀

Input:

stochastic objective function f(θ), step α, exponential decay rates for
the moment estimates [β₁, β₂], small scalar ϵ, and worker id i

Initialize: Δ₀ ← 0, ρ₀ ← 0, n ← 0, m₀^{(init)} ← 0, v₀^{(init)} ← 0
Initialize: θ_{0,i} ← θ₀, m_{0,i} ← 0, v_{0,} [symbol] ← 0, t ← 0, k ← 0

| 1: | while θ [symbol] , not converged do | |
|---|---|---|
| 2: | t ← t + 1 | % number of local steps |
| 3: | k ← k + 1 | % number of Adam steps w.r.t. moment buffers |
| 4: | ${g}_{t , i} ← \frac{\partial {f}_{t} ( θ )}{\partial {θ}_{t - 1 , i}}$ | |
| 5: | m_{t,i} ← β₁m_{t-1,i} + (1 − β₁)gt,i | |
| 6: | v_{t,i} ← β₂v_{t-1,i} + (1 − β₂)gt,i ⊙ gt,i | |
| 7: | \hat{m}_{t,i} ← m_{t,i}/(1 − β₁^{k}), \hat{v}_{t,i} ← v_{t,i}/(1 − β₂^{k}) | |
| 8: | ${θ}_{t , i} ← {θ}_{t - 1 , i} - α {\hat{m}}_{t , i} / ( e + \sqrt{{\hat{υ}}_{t , i}} )$ | |
| 9: | if t divides τ then | |
| 10: | n ← n + 1 | % number of BMUF steps |

| | |
|---|---|
| 11: | Get θ̅ [symbol] , m̅ₜ, v̅ₜ, by all-reduce |
| 12: | Δₙ ← ηΔₙ₋₁ + ζ (θ̅ [symbol] − θ [symbol] ) |
| 13: | θ [symbol] ← θ [symbol] + Δₙ, θt,i ← θt |
| 14: | ρₙ ← ηρₙ₋₁ + ζτ |
| 15: | ${m}_{t}^{( init )} = \frac{{β}_{1}^{ζτ + {ηρ}_{n - 1}} - {β}_{1}^{τ}}{1 - {β}_{1}^{τ}} {m}_{t - τ}^{( init )} + \frac{1 - {β}_{1}^{ζτ + {ηρ}_{n - 1}}}{1 - {β}_{1}^{τ}} {\overline{m}}_{t}$ |
| 16: | ${v}_{t}^{( init )} = \frac{{β}_{2}^{ζτ + {ηρ}_{n - 1}} - {β}_{2}^{τ}}{1 - {β}_{2}^{τ}} {v}_{i - τ}^{( init )} + \frac{1 - {β}_{2}^{ζτ + {ηρ}_{n - 1}}}{1 - {β}_{2}^{τ}} {\overline{v}}_{t}$ |
| 17: | m_{t,i} ← mt^{(init)}, υ [symbol] ← υₜ^{(init)}, k ← k − τ + ζτ + ηρₙ₋₁ |
| 18: | end if |
| 19: | end while |
| 20: | return θt |

[symbol]

indicates data missing or illegible when filed

Algorithm 2 BMUF-NBM-Adam Algorithm

Input:

number of workers N, sync period τ, block momentum η, and initial
parameter θ₀

Input:

stochastic objective function f(θ), step α, exponential decay rates for
the moment estimates [β₁, β₂], small scalar ϵ, and worker id i

Initialize: Δ₀ ← 0, ρ₀ ← 0, n ← 0, m₀^{(init)} ← 0, v₀^{(init)} ← 0
Initialize: θ_{0,i} ← θ₀, m_{0,i} ← 0, v_{0,} [symbol] ← 0, t ← 0, k ← 0

| 1: | while θ [symbol] , not converged do | |
|---|---|---|
| 2: | t ← t + 1 | % number of local steps |
| 3: | k ← k + 1 | % number of Adam steps w.r.t. moment buffers |
| 4: | ${g}_{t , i} ← \frac{\partial {f}_{t} ( θ )}{\partial {θ}_{t - 1 , i}}$ | |
| 5: | m_{t,i} ← β₁m_{t-1,i} + (1 − β₁)gt,i | |
| 6: | v_{t,i} ← β₂v_{t-1,i} + (1 − β₂)gt,i ⊙ gt,i | |
| 7: | \hat{m}_{t,i} ← m_{t,i}/(1 − β₁^{k}), \hat{v}_{t,i} ← v_{t,i}/(1 − β₂^{k}) | |
| 8: | ${θ}_{t , i} ← {θ}_{t - 1 , i} - α {\hat{m}}_{t , i} / ( e + \sqrt{{\hat{υ}}_{t , i}} )$ | |
| 9: | if t divides τ then | |
| 10: | n ← n + 1 | % number of BMUF steps |

| | |
|---|---|
| 11: | Get θ̅ [symbol] , m̅ₜ, v̅ₜ, by all-reduce |
| 12: | Δₙ ← ηΔₙ₋₁ + ζ (θ̅ [symbol] − θ [symbol] ) |
| 13: | θ [symbol] ← θ [symbol] + Δₙ, θt,i ← θt |
| 14: | ρₙ ← ηρₙ₋₁ + ζτ |
| 15: | ${m}_{t}^{( init )} = \frac{{β}_{1}^{ζτ + {ηρ}_{n}} - {β}_{1}^{τ}}{1 - {β}_{1}^{τ}} {m}_{t - τ}^{( init )} + \frac{1 - {β}_{1}^{ζτ + {ηρ}_{n}}}{1 - {β}_{1}^{τ}} {\overline{m}}_{t}$ |
| 16: | ${v}_{t}^{( init )} = \frac{{β}_{2}^{ζτ + {ηρ}_{n}} - {β}_{2}^{τ}}{1 - {β}_{2}^{τ}} {v}_{t - τ}^{( init )} + \frac{1 - {β}_{2}^{ζτ + {ηρ}_{n}}}{1 - {β}_{2}^{τ}} {\overline{v}}_{t}$ |
| 17: | m_{t,i} ← mt^{(init)}, υ [symbol] ← υₜ^{(init)}, k ← k − τ + ζτ + ηρₙ₋₁ |
| 18: | end if |
| 19: | end while |
| 20: | return θt |

[symbol]

indicates data missing or illegible when filed

### Examples of BMUF-RMSProp Optimization

RMSProp optimization is another example of adaptive learning rate stochastic optimization, and has shown good adaptation of learning rate in different applications. According to some embodiments of the present disclosure, BMUF-RMSProp optimization may be used to update a global second-order moment vₜ^{(init)} of stochastic gradient in the RMSprop optimization.

For example, the following Algorithm 3 shows an example BMUF-RMSProp optimization algorithm for CBM, and the following Algorithm 4 shows an example BMUF-RMSProp optimization algorithm for NBM. According to Algorithm 3 and Algorithm 4, the global second-order moment vₜ^{(init)} of stochastic gradient in RMSProp can be updated to be compatible with the global model parameter updated by BMUF.

Algorithm 3 BMUF-CBM-RMSProp Algorithm

Input:

number of workers N, sync period τ, block momentum η, and initial
parameter θ₀

Input:

stochastic objective function f(θ), step α, exponential decay rate β,
small scalar ϵ, and worker id i

Initialize: Δ₀ ← 0, ρ₀ ← 0, n ← 0, v₀^{(init)} ← 0
Initialize: θ_{0,i} ← θ₀, v_{0,i} ← 0, t ← 0

| 1: | while θₜ, not converged do | |
|---|---|---|
| 2: | t ← t + 1 | % number of local steps |
| 3: | ${g}_{t , i} ← \frac{\partial {f}_{t} ( θ )}{\partial {θ}_{t - 1 , i}}$ | |
| 4: | v_{t,i} ← β₂v_{t-1,i} + (1 − β₂)gt,i ⊙ gt,i | |
| 5: | ${θ}_{t , i} ← {θ}_{t - 1 , i} - α {g}_{t , i} / ( ϵ + \sqrt{{υ}_{t , i}} )$ | |
| 6: | if t divides τ then | |
| 7: | n ← n + 1 | % number of BMUF steps |

| | |
|---|---|
| 8: | Get θ̅ [symbol] , m̅ₜ, v̅ₜ, by all-reduce |
| 9: | Δₙ ← ηΔₙ₋₁ + ζ (θ̅ [symbol] − θ [symbol] ) |
| 10: | θ [symbol] ← θ [symbol] + Δₙ, θt,i ← θt |
| 11: | ρₙ ← ηρₙ₋₁ + ζτ |
| 12: | ${v}_{t}^{( init )} = \frac{{β}^{ζτ + {ηρ}_{n - 1}} - {β}^{τ}}{1 - {β}^{τ}} {v}_{t - τ}^{( init )} + \frac{1 - {β}^{ζτ + {ηρ}_{n - 1}}}{1 - {β}^{τ}} {\overline{v}}_{t}$ |
| 13: | υ [symbol] ← υₜ^{(init)} |
| 14: | end if |
| 15: | end while |
| 16: | return θt |

[symbol]

indicates data missing or illegible when filed

Algorithm 4 BMUF-NBM-RMSProp Algorithm

Input:

number of workers N, sync period τ, block momentum η, and initial
parameter θ₀

Input:

stochastic objective function f(θ), step α, exponential decay rate β,
small scalar ϵ, and worker id i

Initialize: Δ₀ ← 0, ρ₀ ← 0, n ← 0, v₀^{(init)} ← 0
Initialize: θ_{0,i} ← θ₀, v_{0,i} ← 0, t ← 0

| 1: | while θₜ, not converged do | |
|---|---|---|
| 2: | t ← t + 1 | % number of local steps |
| 3: | ${g}_{t , i} ← \frac{\partial {f}_{t} ( θ )}{\partial {θ}_{t - 1 , i}}$ | |
| 4: | v_{t,i} ← β₂v_{t-1,i} + (1 − β₂)gt,i ⊙ gt,i | |
| 5: | ${θ}_{t , i} ← {θ}_{t - 1 , i} - α {g}_{t , i} / ( ϵ + \sqrt{{υ}_{t , i}} )$ | |
| 6: | if t divides τ then | |
| 7: | n ← n + 1 | % number of BMUF steps |

| | |
|---|---|
| 8: | Get θ̅ [symbol] , m̅ₜ, v̅ₜ, by all-reduce |
| 9: | Δₙ ← ηΔₙ₋₁ + ζ (θ̅ [symbol] − θ [symbol] ) |
| 10: | θ [symbol] ← θ [symbol] + Δₙ, θt,i ← θt |
| 11: | ρₙ ← ηρₙ₋₁ + ζτ |
| 12: | ${v}_{t}^{( init )} = \frac{{β}^{ζτ + {ηρ}_{n}} - {β}^{τ}}{1 - {β}^{τ}} {v}_{t - τ}^{( init )} + \frac{1 - {β}^{ζτ + {ηρ}_{n}}}{1 - {β}^{τ}} {\overline{v}}_{t}$ |
| 13: | υ [symbol] ← υₜ^{(init)} |
| 14: | end if |
| 15: | end while |
| 16: | return θt |

[symbol]

indicates data missing or illegible when filed

### Examples of BMUF-Adadelta Optimization

Adadelta optimization is yet another example of adaptive learning rate stochastic optimization, which adapts the learning rate over time. According to some embodiments of the present disclosure, BMUF-Adadelta optimization may be used to update a global second-order moment [symbol] ₜ^{(init)} of stochastic gradient and a global second-order moment μₜ^{(init)} of a scaled model update vector in the RMSprop optimization.

For example, the following Algorithm 5 shows an example BMUF-Adadelta optimization algorithm for CBM, and the following Algorithm 6 shows an example BMUF-Adadelta optimization algorithm for NBM. According to Algorithm 5 and Algorithm 6, the global second-order moment [symbol] ₜ^{(init)} of stochastic gradient and the global second-order moment μₜ^{(init)} of the model update vector in RMSProp optimization can be updated to be compatible with the global model parameter updated by BMUF.

Algorithm 5 BMUF-CBM-Adadelta Algorithm

Input:

number of workers N, sync period τ, block momentum η, and initial
parameter θ₀

Input:

stochastic objective function f(θ), step α, exponential decay rate β,
small scalar ϵ, and worker id i

Initialize: Δ₀ ← 0, ρ₀ ← 0, n ← 0, [symbol] ₀^{(init)} ← 0
Initialize: θ_{0,i} ← θ₀, [symbol] _{0,i} ← 0, t ← 0

| 1: | while θₜ, not converged do | |
|---|---|---|
| 2: | t ← t + 1 | % number of local steps |
| 3: | ${g}_{t , i} ← \frac{\partial {f}_{t} ( θ )}{\partial {θ}_{t - 1 , i}}$ | |
| 4: | [symbol] _{t,i} ← β [symbol] _{t-1,i} + (1 − β)gt,i ⊙ gt,i | |
| 5: | ${δ}_{t , i} ← \frac{\sqrt{{μ}_{t - 1 , i}}}{\sqrt{{v}_{t , i}} + ϵ} {g}_{t , i}$ | |
| 6: | μ_{t,i} ← βμ_{t-1,i} + (1 − β)δt,i ⊙ δt,i | |
| 7: | θ_{t,i} ← θ [symbol] − αδ_{t,i} | |
| 8: | if t divides τ then | |
| 9: | n ← n + 1 | % number of BMUF steps |

| | |
|---|---|
| 10: | Get θ̅ [symbol] , m̅ₜ, v̅ₜ, by all-reduce |
| 11: | Δₙ ← ηΔₙ₋₁ + ζ (θ̅ [symbol] − θ [symbol] ) |
| 12: | θ [symbol] ← θ [symbol] + Δₙ, θt,i ← θt |
| 13: | ρₙ ← ηρₙ₋₁ + ζτ |
| 14: | ${v}_{t}^{( init )} = \frac{{β}^{ζτ + {ηρ}_{n - 1}} - {β}^{τ}}{1 - {β}^{τ}} {v}_{t - τ}^{( init )} + \frac{1 - {β}^{ζτ + {ηρ}_{n - 1}}}{1 - {β}^{τ}} {\overline{v}}_{t}$ |
| 15: | ${μ}_{t}^{( init )} = \frac{{β}^{ζτ + {ηρ}_{n - 1}} - {β}^{τ}}{1 - {β}^{τ}} {μ}_{t - τ}^{( init )} + \frac{1 - {β}^{ζτ + {ηρ}_{n - 1}}}{1 - {β}^{τ}} {\overline{μ}}_{t}$ |
| 16: | [symbol] _{t,i} ← [symbol] ₜ^{(init)}, μ_{t,i} ← μₜ^{(init)} |
| 17: | end if |
| 18: | end while |
| 19: | return θt |

[symbol]

indicates data missing or illegible when filed

Algorithm 6 BMUF-NBM-Adadelta Algorithm

Input:

number of workers N, sync period τ, block momentum η, and initial
parameter θ₀

Input:

stochastic objective function f(θ), step α, exponential decay rate β,
small scalar ϵ, and worker id i

Initialize: Δ₀ ← 0, ρ₀ ← 0, n ← 0, [symbol] ₀^{(init)} ← 0
Initialize: θ_{0,i} ← θ₀, [symbol] _{0,i} ← 0, t ← 0

| 1: | while θₜ, not converged do | |
|---|---|---|
| 2: | t ← t + 1 | % number of local steps |
| 3: | ${g}_{t , i} ← \frac{\partial {f}_{t} ( θ )}{\partial {θ}_{t - 1 , i}}$ | |
| 4: | [symbol] _{t,i} ← β [symbol] _{t-1,i} + (1 − β)gt,i ⊙ gt,i | |
| 5: | ${δ}_{t , i} ← \frac{\sqrt{{μ}_{t - 1 , i}}}{\sqrt{{v}_{t , i}} + ϵ} {g}_{t , i}$ | |
| 6: | μ_{t,i} ← βμ_{t-1,i} + (1 − β)δt,i ⊙ δt,i | |
| 7: | θ_{t,i} ← θ [symbol] − αδ_{t,i} | |
| 8: | if t divides τ then | |
| 9: | n ← n + 1 | % number of BMUF steps |

| | |
|---|---|
| 10: | Get θ̅ [symbol] , m̅ₜ, v̅ₜ, by all-reduce |
| 11: | Δₙ ← ηΔₙ₋₁ + ζ (θ̅ [symbol] − θ [symbol] ) |
| 12: | θ [symbol] ← θ [symbol] + Δₙ, θt,i ← θt |
| 13: | ρₙ ← ηρₙ₋₁ + ζτ |
| 14: | ${v}_{t}^{( init )} = \frac{{β}^{ζτ + {ηρ}_{n}} - {β}^{τ}}{1 - {β}^{τ}} {v}_{t - τ}^{( init )} + \frac{1 - {β}^{ζτ + {ηρ}_{n}}}{1 - {β}^{τ}} {\overline{v}}_{t}$ |
| 15: | ${θ}_{t , i} ← {θ}_{t - 1 , i} - α {\hat{m}}_{t , i} / ( e + \sqrt{{\hat{υ}}_{t , i}} )$ |
| 16: | [symbol] _{t,i} ← [symbol] ₜ^{(init)}, μ_{t,i} ← μₜ^{(init)} |
| 17: | end if |
| 18: | end while |
| 19: | return θt |

[symbol]

indicates data missing or illegible when filed

### Example Method

FIG. 4 illustrates a flow chart of a method 400 for parallelizing moment-based optimization with BMUF according to some embodiments of the present disclosure. The method 400 may be implemented at a master node such as the master node 210 in FIG. 2.

At block 405, the master node provides a global model parameter and a global moment parameter to a plurality of worker nodes (e.g., worker nodes 220). At block 410, the master node receives, from the plurality of worker nodes, a plurality of local model parameters and a plurality of local moment parameters. The plurality of local model parameters and the plurality of local moment parameters are generated by respective ones of the plurality of worker nodes performing moment-based optimizations in parallel for the training cycle based on the global model parameter and the global moment parameter.

At block 415, the master node aggregates the plurality of local model parameters to obtain an aggregated model parameter and aggregates the plurality of local moment parameters to obtain an aggregated moment parameter. At block 420, the master node generates model update information for the training cycle based on the aggregated model parameter and historical model update information for a preceding training cycle. At block 425, the master node updates the global model parameter based on the model update information for the training cycle to obtain an updated global model parameter. At block 430, the master node updates the global moment parameter based on the aggregated moment parameter to obtain an updated global moment parameter compatible with the updated global model parameter. At block 435, the master node provides the updated global model parameter and the updated global moment parameter to the plurality of worker nodes for performing moment-based optimizations in parallel for a succeeding training cycle.

In some embodiments, each local model parameter and each local moment parameter are generated by one of the plurality of worker nodes performing moment-based optimizations for the training cycle with a predetermined number of mini-batches of training data. In some embodiments, to update the global moment parameter, the master node may determine the number of equivalent mini-batches for the training cycle based on the predetermined number of mini-batches and the number of equivalent mini-batches for the preceding training cycle, the number of equivalent mini-batches for a training cycle representing a converted number of mini-batches used to generate the model update information for the training cycle; and update the global moment parameter based on the aggregated moment parameter and the number of equivalent mini-batches for the training cycle.

In some embodiments, to update the global moment parameter based on the aggregated moment parameter and the number of equivalent mini-batches for the training cycle, the master node may determine a first weight for the global moment parameter and a second weight for the aggregated moment parameter based on an exponential decay rate and the number of equivalent mini-batches for the training cycle; and generate a weighted sum of the global moment parameter with the first weight and the aggregated moment parameter with the second weight to obtain the updated global moment parameter.

In some embodiments, to update the global model parameter comprises, the master node may update the global model parameter based on the model update information for the training cycle to obtain an intermediate updated global model parameter; and update the intermediate updated global model parameter based on the model update information for the training cycle to obtain the updated global model parameter.

In some embodiments, each local model parameter and each local moment parameter are generated by one of the plurality of worker nodes performing moment-based optimizations for the training cycle with a predetermined number of mini-batches of training data. In some embodiments, to update the global moment parameter, the master node may determine the number of equivalent mini-batches for the training cycle based on the predetermined number of mini-batches and the number of equivalent mini-batches for the preceding training cycle, the number of equivalent mini-batches for a training cycle representing a converted number of mini-batches used to generate the model update information for the training cycle; determine the number of equivalent mini-batches for the succeeding training cycle based on the predetermined number of mini-batches and the number of equivalent mini-batches for the training cycle; and update the global moment parameter based on the aggregated moment parameter and the number of equivalent mini-batches for the succeeding training cycle.

In some embodiments, to generate the updated global moment parameter, the master node may assign a first weight to the global first-order moment and a second weight to the aggregated first-order moment based on the number of equivalent mini-batches and a first exponential decay rate; generate an updated global first-order moment by weighting the global first-order moment and the aggregated first-order moment with the first and second weights, respectively; assign a third weight to the global second-order moment and a fourth weight to the aggregated second-order moment based on the number of equivalent mini-batches and a second exponential decay rate; and generate an updated global second-order moment by weighting the global second-order moment and the aggregated second-order moment with the third and fourth weights, respectively.

In some embodiments, to update the global moment parameter, the master node may determine a third weight for the global moment parameter and a fourth weight for the aggregated moment parameter based on an exponential decay rate and the number of equivalent mini-batches for the succeeding training cycle; and generate a weighted sum of the global moment parameter with the third weight and the aggregated moment parameter with the fourth weight to obtain the updated global moment parameter.

In some embodiments, to generate the model update information for the training cycle, the master node may generate first model update information based on the aggregated model parameter and a block learning rate; generate second model update information based on the historical model update information for the preceding training cycle and a block momentum; and combine the first model update information and the second model update information to generate the model update information for the training cycle. In some embodiments, to determine the number of equivalent mini-batches for the training cycle, the master node may determine a first number of equivalent mini-batches based on the predetermined number of mini-batches and the block learning rate; determine a second number of equivalent mini-batches based on the number of equivalent mini-batches for the preceding training cycle and the block momentum; and combine the first number of equivalent mini-batches and the second number of equivalent mini-batches to determine the number of equivalent mini-batches for the training cycle.

In some embodiments, the block learning rate is set to 1 and the block momentum is set based on the number of the plurality of worker nodes.

In some embodiments, the moment-based optimizations comprise Adam optimizations, and the master node may further update a bias correction term for the Adam optimizations based on the number of equivalent mini-batches for the training cycle; and provide the updated bias correction term to the plurality of worker nodes for performing the Adam optimizations in parallel for a succeeding training cycle.

The functionalities described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single implementation. Conversely, various features that are described in the context of a single implementation may also be implemented in multiple embodiments separately or in any suitable sub-combination.

Some example embodiments of the present disclosure are listed below.

In a first aspect, there is provided a computer-implemented method. The method comprises: providing, by a master node, a global model parameter and a global moment parameter to a plurality of worker nodes for a training cycle; receiving, from the plurality of worker nodes, a plurality of local model parameters and a plurality of local moment parameters, the plurality of local model parameters and the plurality of local moment parameters being generated by respective ones of the plurality of worker nodes performing moment-based optimizations in parallel for the training cycle based on the global model parameter and the global moment parameter; aggregating the plurality of local model parameters to obtain an aggregated model parameter and aggregating the plurality of local moment parameters to obtain an aggregated moment parameter; generating model update information for the training cycle based on the aggregated model parameter and historical model update information for a preceding training cycle; updating the global model parameter based on the model update information for the training cycle to obtain an updated global model parameter; updating the global moment parameter based on the aggregated moment parameter to obtain an updated global moment parameter compatible with the updated global model parameter; and providing the updated global model parameter and the updated global moment parameter to the plurality of worker nodes for performing moment-based optimizations in parallel for a succeeding training cycle.

In some embodiments, each local model parameter and each local moment parameter are generated by one of the plurality of worker nodes performing the moment-based optimizations for the training cycle with a predetermined number of mini-batches of training data. In some embodiments, updating the global moment parameter comprises: determining the number of equivalent mini-batches for the training cycle based on the predetermined number of mini-batches and the number of equivalent mini-batches for the preceding training cycle, the number of equivalent mini-batches for a training cycle representing a converted number of mini-batches used to generate the model update information for the training cycle; and updating the global moment parameter based on the aggregated moment parameter and the number of equivalent mini-batches for the training cycle.

In some embodiments, updating the global moment parameter comprises: determining a first weight for the global moment parameter and a second weight for the aggregated moment parameter based on an exponential decay rate and the number of equivalent mini-batches for the training cycle; and generating a weighted sum of the global moment parameter with the first weight and the aggregated moment parameter with the second weight to obtain the updated global moment parameter.

In some embodiments, updating the global model parameter comprises: updating the global model parameter based on the model update information for the training cycle to obtain an intermediate updated global model parameter; and updating the intermediate updated global model parameter based on the model update information for the training cycle to obtain the updated global model parameter.

In some embodiments, each local model parameter and each local moment parameter are generated by one of the plurality of worker nodes performing the moment-based optimizations for the training cycle with a predetermined number of mini-batches of training data. In some embodiments, updating the global moment parameter comprises: determining the number of equivalent mini-batches for the training cycle based on the predetermined number of mini-batches and the number of equivalent mini-batches for the preceding training cycle, the number of equivalent mini-batches for a training cycle representing a converted number of mini-batches used to generate the model update information for the training cycle; determining the number of equivalent mini-batches for the succeeding training cycle based on the predetermined number of mini-batches and the number of equivalent mini-batches for the training cycle; and updating the global moment parameter based on the aggregated moment parameter and the number of equivalent mini-batches for the succeeding training cycle.

In some embodiments, updating the global moment parameter comprises: determining a third weight for the global moment parameter and a fourth weight for the aggregated moment parameter based on an exponential decay rate and the number of equivalent mini-batches for the succeeding training cycle; and generating a weighted sum of the global moment parameter with the third weight and the aggregated moment parameter with the fourth weight to obtain the updated global moment parameter.

In some embodiments, generating the model update information for the training cycle comprises: generating first model update information based on the aggregated model parameter and a block learning rate; generating second model update information based on the historical model update information for the preceding training cycle and a block momentum; and combining the first model update information and the second model update information to generate the model update information for the training cycle. In some embodiments, determining the number of equivalent mini-batches for the training cycle comprises: determining a first number of equivalent mini-batches based on the predetermined number of mini-batches and the block learning rate; determining a second number of equivalent mini-batches based on the number of equivalent mini-batches for the preceding training cycle and the block momentum; and combining the first number of equivalent mini-batches and the second number of equivalent mini-batches to determine the number of equivalent mini-batches for the training cycle.

In some embodiments, the block learning rate is set to 1 and the block momentum is set based on the number of the plurality of worker nodes.

In some embodiments, the moment-based optimizations comprise Adam optimizations, the method further comprising: updating a bias correction term for the Adam optimizations based on the number of equivalent mini-batches for the training cycle; and providing the updated bias correction term to the plurality of worker nodes for performing the Adam optimizations in parallel for a succeeding training cycle.

In a second aspect, there is provided an electronic device. The electronic device comprises a processing unit and a memory coupled to the processing unit and storing instructions thereon. The instructions, when executed by the processing unit, perform acts comprising: providing, by a master node, a global model parameter and a global moment parameter to a plurality of worker nodes for a training cycle; receiving, from the plurality of worker nodes, a plurality of local model parameters and a plurality of local moment parameters, the plurality of local model parameters and the plurality of local moment parameters being generated by respective ones of the plurality of worker nodes performing moment-based optimizations in parallel for the training cycle based on the global model parameter and the global moment parameter; aggregating the plurality of local model parameters to obtain an aggregated model parameter and aggregating the plurality of local moment parameters to obtain an aggregated moment parameter; generating model update information for the training cycle based on the aggregated model parameter and historical model update information for a preceding training cycle; updating the global model parameter based on the model update information for the training cycle to obtain an updated global model parameter; updating the global moment parameter based on the aggregated moment parameter to obtain an updated global moment parameter compatible with the updated global model parameter; and providing the updated global model parameter and the updated global moment parameter to the plurality of worker nodes for performing moment-based optimizations in parallel for a succeeding training cycle.

In some embodiments, each local model parameter and each local moment parameter are generated by one of the plurality of worker nodes performing the moment-based optimizations for the training cycle with a predetermined number of mini-batches of training data. In some embodiments, updating the global moment parameter comprises: determining the number of equivalent mini-batches for the training cycle based on the predetermined number of mini-batches and the number of equivalent mini-batches for the preceding training cycle, the number of equivalent mini-batches for a training cycle representing a converted number of mini-batches used to generate the model update information for the training cycle; and updating the global moment parameter based on the aggregated moment parameter and the number of equivalent mini-batches for the training cycle.

In some embodiments, updating the global moment parameter comprises: determining a first weight for the global moment parameter and a second weight for the aggregated moment parameter based on an exponential decay rate and the number of equivalent mini-batches for the training cycle; and generating a weighted sum of the global moment parameter with the first weight and the aggregated moment parameter with the second weight to obtain the updated global moment parameter.

In some embodiments, updating the global model parameter comprises: updating the global model parameter based on the model update information for the training cycle to obtain an intermediate updated global model parameter; and updating the intermediate updated global model parameter based on the model update information for the training cycle to obtain the updated global model parameter.

In some embodiments, each local model parameter and each local moment parameter are generated by one of the plurality of worker nodes performing the moment-based optimizations for the training cycle with a predetermined number of mini-batches of training data. In some embodiments, updating the global moment parameter comprises: determining the number of equivalent mini-batches for the training cycle based on the predetermined number of mini-batches and the number of equivalent mini-batches for the preceding training cycle, the number of equivalent mini-batches for a training cycle representing a converted number of mini-batches used to generate the model update information for the training cycle; determining the number of equivalent mini-batches for the succeeding training cycle based on the predetermined number of mini-batches and the number of equivalent mini-batches for the training cycle; and updating the global moment parameter based on the aggregated moment parameter and the number of equivalent mini-batches for the succeeding training cycle.

In some embodiments, updating the global moment parameter comprises: determining a third weight for the global moment parameter and a fourth weight for the aggregated moment parameter based on an exponential decay rate and the number of equivalent mini-batches for the succeeding training cycle; and generating a weighted sum of the global moment parameter with the third weight and the aggregated moment parameter with the fourth weight to obtain the updated global moment parameter.

In some embodiments, generating the model update information for the training cycle comprises: generating first model update information based on the aggregated model parameter and a block learning rate; generating second model update information based on the historical model update information for the preceding training cycle and a block momentum; and combining the first model update information and the second model update information to generate the model update information for the training cycle. In some embodiments, determining the number of equivalent mini-batches for the training cycle comprises: determining a first number of equivalent mini-batches based on the predetermined number of mini-batches and the block learning rate; determining a second number of equivalent mini-batches based on the number of equivalent mini-batches for the preceding training cycle and the block momentum; and combining the first number of equivalent mini-batches and the second number of equivalent mini-batches to determine the number of equivalent mini-batches for the training cycle.

In some embodiments, the block learning rate is set to 1 and the block momentum is set based on the number of the plurality of worker nodes.

In some embodiments, the moment-based optimizations comprise Adam optimizations, the acts further comprising: updating a bias correction term for the Adam optimizations based on the number of equivalent mini-batches for the training cycle; and providing the updated bias correction term to the plurality of worker nodes for performing the Adam optimizations in parallel for a succeeding training cycle.

In a third aspect, there is provided a computer program product. The computer program product comprises executable instructions. The executable instructions, when executed on a device, cause the device to perform acts. The acts comprise: providing, by a master node, a global model parameter and a global moment parameter to a plurality of worker nodes for a training cycle; receiving, from the plurality of worker nodes, a plurality of local model parameters and a plurality of local moment parameters, the plurality of local model parameters and the plurality of local moment parameters being generated by respective ones of the plurality of worker nodes performing moment-based optimizations in parallel for the training cycle based on the global model parameter and the global moment parameter; aggregating the plurality of local model parameters to obtain an aggregated model parameter and aggregating the plurality of local moment parameters to obtain an aggregated moment parameter; generating model update information for the training cycle based on the aggregated model parameter and historical model update information for a preceding training cycle; updating the global model parameter based on the model update information for the training cycle to obtain an updated global model parameter; updating the global moment parameter based on the aggregated moment parameter to obtain an updated global moment parameter compatible with the updated global model parameter; and providing the updated global model parameter and the updated global moment parameter to the plurality of worker nodes for performing moment-based optimizations in parallel for a succeeding training cycle.

In some embodiments, each local model parameter and each local moment parameter are generated by one of the plurality of worker nodes performing the moment-based optimizations for the training cycle with a predetermined number of mini-batches of training data. In some embodiments, updating the global moment parameter comprises: determining the number of equivalent mini-batches for the training cycle based on the predetermined number of mini-batches and the number of equivalent mini-batches for the preceding training cycle, the number of equivalent mini-batches for a training cycle representing a converted number of mini-batches used to generate the model update information for the training cycle; and updating the global moment parameter based on the aggregated moment parameter and the number of equivalent mini-batches for the training cycle.

In some embodiments, updating the global moment parameter comprises: determining a first weight for the global moment parameter and a second weight for the aggregated moment parameter based on an exponential decay rate and the number of equivalent mini-batches for the training cycle; and generating a weighted sum of the global moment parameter with the first weight and the aggregated moment parameter with the second weight to obtain the updated global moment parameter.

In some embodiments, updating the global model parameter comprises: updating the global model parameter based on the model update information for the training cycle to obtain an intermediate updated global model parameter; and updating the intermediate updated global model parameter based on the model update information for the training cycle to obtain the updated global model parameter.

In some embodiments, each local model parameter and each local moment parameter are generated by one of the plurality of worker nodes performing the moment-based optimizations for the training cycle with a predetermined number of mini-batches of training data. In some embodiments, updating the global moment parameter comprises: determining the number of equivalent mini-batches for the training cycle based on the predetermined number of mini-batches and the number of equivalent mini-batches for the preceding training cycle, the number of equivalent mini-batches for a training cycle representing a converted number of mini-batches used to generate the model update information for the training cycle; determining the number of equivalent mini-batches for the succeeding training cycle based on the predetermined number of mini-batches and the number of equivalent mini-batches for the training cycle; and updating the global moment parameter based on the aggregated moment parameter and the number of equivalent mini-batches for the succeeding training cycle.

In some embodiments, updating the global moment parameter comprises: determining a third weight for the global moment parameter and a fourth weight for the aggregated moment parameter based on an exponential decay rate and the number of equivalent mini-batches for the succeeding training cycle; and generating a weighted sum of the global moment parameter with the third weight and the aggregated moment parameter with the fourth weight to obtain the updated global moment parameter.

In some embodiments, generating the model update information for the training cycle comprises: generating first model update information based on the aggregated model parameter and a block learning rate; generating second model update information based on the historical model update information for the preceding training cycle and a block momentum; and combining the first model update information and the second model update information to generate the model update information for the training cycle. In some embodiments, determining the number of equivalent mini-batches for the training cycle comprises: determining a first number of equivalent mini-batches based on the predetermined number of mini-batches and the block learning rate; determining a second number of equivalent mini-batches based on the number of equivalent mini-batches for the preceding training cycle and the block momentum; and combining the first number of equivalent mini-batches and the second number of equivalent mini-batches to determine the number of equivalent mini-batches for the training cycle.

In some embodiments, the block learning rate is set to 1 and the block momentum is set based on the number of the plurality of worker nodes.

In some embodiments, the moment-based optimizations comprise Adam optimizations, the acts further comprising: updating a bias correction term for the Adam optimizations based on the number of equivalent mini-batches for the training cycle; and providing the updated bias correction term to the plurality of worker nodes for performing the Adam optimizations in parallel for a succeeding training cycle.

Although the present disclosure has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments.

What is claimed is:

1. A computer-implemented method, comprising:
providing, by a master node, a global model parameter and a global moment parameter to a plurality of worker nodes for a training cycle;
receiving, from the plurality of worker nodes, a plurality of local model parameters and a plurality of local moment parameters, the plurality of local model parameters and the plurality of local moment parameters being generated by respective ones of the plurality of worker nodes performing moment-based optimizations in parallel for the training cycle based on the global model parameter and the global moment parameter;
aggregating the plurality of local model parameters to obtain an aggregated model parameter and aggregating the plurality of local moment parameters to obtain an aggregated moment parameter;
generating model update information for the training cycle based on the aggregated model parameter and historical model update information for a preceding training cycle;
updating the global model parameter based on the model update information for the training cycle to obtain an updated global model parameter;
updating the global moment parameter based on the aggregated moment parameter to obtain an updated global moment parameter compatible with the updated global model parameter; and
providing the updated global model parameter and the updated global moment parameter to the plurality of worker nodes for performing moment-based optimizations in parallel for a succeeding training cycle.

2. The method of claim 1, wherein each local model parameter and each local moment parameter are generated by one of the plurality of worker nodes performing the moment-based optimizations for the training cycle with a predetermined number of mini-batches of training data, and updating the global moment parameter comprises:
determining the number of equivalent mini-batches for the training cycle based on the predetermined number of mini-batches and the number of equivalent mini-batches for the preceding training cycle, the number of equivalent mini-batches for a training cycle representing a converted number of mini-batches used to generate the model update information for the training cycle; and
updating the global moment parameter based on the aggregated moment parameter and the number of equivalent mini-batches for the training cycle.

3. The method of claim 2, wherein updating the global moment parameter comprises:
determining a first weight for the global moment parameter and a second weight for the aggregated moment parameter based on an exponential decay rate and the number of equivalent mini-batches for the training cycle; and
generating a weighted sum of the global moment parameter with the first weight and the aggregated moment parameter with the second weight to obtain the updated global moment parameter.

4. The method of claim 1, wherein updating the global model parameter comprises:
updating the global model parameter based on the model update information for the training cycle to obtain an intermediate updated global model parameter; and
updating the intermediate updated global model parameter based on the model update information for the training cycle to obtain the updated global model parameter.

5. The method of claim 4, wherein each local model parameter and each local moment parameter are generated by one of the plurality of worker nodes performing the moment-based optimizations for the training cycle with a predetermined number of mini-batches of training data, and updating the global moment parameter comprises:
determining the number of equivalent mini-batches for the training cycle based on the predetermined number of mini-batches and the number of equivalent mini-batches for the preceding training cycle, the number of equivalent mini-batches for a training cycle representing a converted number of mini-batches used to generate the model update information for the training cycle;
determining the number of equivalent mini-batches for the succeeding training cycle based on the predetermined number of mini-batches and the number of equivalent mini-batches for the training cycle; and
updating the global moment parameter based on the aggregated moment parameter and the number of equivalent mini-batches for the succeeding training cycle.

6. The method of claim 5, wherein updating the global moment parameter comprises:
determining a third weight for the global moment parameter and a fourth weight for the aggregated moment parameter based on an exponential decay rate and the number of equivalent mini-batches for the succeeding training cycle; and
generating a weighted sum of the global moment parameter with the third weight and the aggregated moment parameter with the fourth weight to obtain the updated global moment parameter.

7. The method of claim 2 or 5, wherein generating the model update information for the training cycle comprises:
generating first model update information based on the aggregated model parameter and a block learning rate;
generating second model update information based on the historical model update information for the preceding training cycle and a block momentum; and
combining the first model update information and the second model update information to generate the model update information for the training cycle, and
wherein determining the number of equivalent mini-batches for the training cycle comprises:
determining a first number of equivalent mini-batches based on the predetermined number of mini-batches and the block learning rate;
determining a second number of equivalent mini-batches based on the number of equivalent mini-batches for the preceding training cycle and the block momentum; and
combining the first number of equivalent mini-batches and the second number of equivalent mini-batches to determine the number of equivalent mini-batches for the training cycle.

8. The method of claim 7, wherein the block learning rate is set to 1 and the block momentum is set based on the number of the plurality of worker nodes.

9. The method of claim 2 or 5, wherein the moment-based optimizations comprise Adam optimizations, the method further comprising:
updating a bias correction term for the Adam optimizations based on the number of equivalent mini-batches for the training cycle; and
providing the updated bias correction term to the plurality of worker nodes for performing the Adam optimizations in parallel for a succeeding training cycle.

10. An electronic device, comprising:
a processing unit;
a memory coupled to the processing unit and storing instructions thereon, the instructions, when executed by the processing unit, performing acts comprising:
providing, by a master node, a global model parameter and a global moment parameter to a plurality of worker nodes for a training cycle;
receiving, from the plurality of worker nodes, a plurality of local model parameters and a plurality of local moment parameters, the plurality of local model parameters and the plurality of local moment parameters being generated by respective ones of the plurality of worker nodes performing moment-based optimizations in parallel for the training cycle based on the global model parameter and the global moment parameter;
aggregating the plurality of local model parameters to obtain an aggregated model parameter and aggregating the plurality of local moment parameters to obtain an aggregated moment parameter;
generating model update information for the training cycle based on the aggregated model parameter and historical model update information for a preceding training cycle;
updating the global model parameter based on the model update information for the training cycle to obtain an updated global model parameter;
updating the global moment parameter based on the aggregated moment parameter to obtain an updated global moment parameter compatible with the updated global model parameter; and
providing the updated global model parameter and the updated global moment parameter to the plurality of worker nodes for performing moment-based optimizations in parallel for a succeeding training cycle.

11. The device of claim 10, wherein each local model parameter and each local moment parameter are generated by one of the plurality of worker nodes performing moment-based optimizations for the training cycle with a predetermined number of mini-batches of training data, and updating the global moment parameter comprises:
determining the number of equivalent mini-batches for the training cycle based on the predetermined number of mini-batches and the number of equivalent mini-batches for the preceding training cycle, the number of equivalent mini-batches for a training cycle representing a converted number of mini-batches used to generate the model update information for the training cycle; and
updating the global moment parameter based on the aggregated moment parameter and the number of equivalent mini-batches for the training cycle.

12. The device of claim 11, wherein updating the global moment parameter comprises:
determining a first weight for the global moment parameter and a second weight for the aggregated moment parameter based on an exponential decay rate and the number of equivalent mini-batches for the training cycle; and
generating a weighted sum of the global moment parameter with the first weight and the aggregated moment parameter with the second weight to obtain the updated global moment parameter.

13. The device of claim 10, wherein updating the global model parameter comprises:
updating the global model parameter based on the model update information for the training cycle to obtain an intermediate updated global model parameter; and
updating the intermediate updated global model parameter based on the model update information for the training cycle to obtain the updated global model parameter.

14. The device of claim 13, wherein each local model parameter and each local moment parameter are generated by one of the plurality of worker nodes performing moment-based optimizations for the training cycle with a predetermined number of mini-batches of training data, and updating the global moment parameter comprises:
determining the number of equivalent mini-batches for the training cycle based on the predetermined number of mini-batches and the number of equivalent mini-batches for the preceding training cycle, the number of equivalent mini-batches for a training cycle representing a converted number of mini-batches used to generate the model update information for the training cycle;
determining the number of equivalent mini-batches for the succeeding training cycle based on the predetermined number of mini-batches and the number of equivalent mini-batches for the training cycle; and
updating the global moment parameter based on the aggregated moment parameter and the number of equivalent mini-batches for the succeeding training cycle.

15. A computer program product comprising executable instructions, the executable instructions, when executed on a device, cause the device to perform acts comprising:
providing, by a master node, a global model parameter and a global moment parameter to a plurality of worker nodes for a training cycle;
receiving, from the plurality of worker nodes, a plurality of local model parameters and a plurality of local moment parameters, the plurality of local model parameters and the plurality of local moment parameters being generated by respective ones of the plurality of worker nodes performing moment-based optimizations in parallel for the training cycle based on the global model parameter and the global moment parameter;
aggregating the plurality of local model parameters to obtain an aggregated model parameter and aggregating the plurality of local moment parameters to obtain an aggregated moment parameter;
generating model update information for the training cycle based on the aggregated model parameter and historical model update information for a preceding training cycle;
updating the global model parameter based on the model update information for the training cycle to obtain an updated global model parameter;
updating the global moment parameter based on the aggregated moment parameter to obtain an updated global moment parameter compatible with the updated global model parameter; and
providing the updated global model parameter and the updated global moment parameter to the plurality of worker nodes for performing moment-based optimizations in parallel for a succeeding training cycle.
